(19) United States
(12) Patent Application Publication
(10) Pub. No.: US 2004/0099081 A1
(43) Pub. Date: May 27, 2004

(54) Robotic arm

(76) Inventors: Alain Riwan, L'hay les Roses (FR); Dominique Ponsort, Bievres (FR)

Correspondence Address: Thelen Reid & Priest, P O Box 640640, San Jose, CA, 95164-0640, US

(21) Appl. No.: 10/276,354

(22) PCT Filed: May 18, 2001
(86) PCT No.: PCT/FR01/01529

(30) Foreign Application Priority Data
May 18, 2000 (FR) 00/06365

(51) Int. Cl. B25J 17/00

(52) U.S. Cl. 74/490.01

(57) ABSTRACT

This master arm comprises a wrist (6) held at a constant global inclination to achieve excellent decoupling of translation controls accomplished by moving segments (3, 4) and rotation controls, accomplished by turning the wrist. The operator's task is facilitated and kinetic singularities are almost entirely eliminated. One special embodiment comprises a wrist holder (5) and a special link (18 to 22) that connects the wrist holder to a fixed base; and moving elements (7, 8, 9) of the wrist (6) have hinge pins meeting at a point (0). Thus, the wrist (6) is balanced in rotation and applies a constant force on the segments (3, 4) of the arm, so that they can easily be balanced by a static feedback means. Therefore, the arm can remain in a stable position even when it is released.

The purpose of this invention is a control arm, and more particularly a master arm or an arm to control a virtual reality simulation. The state of the arm is recorded by position sensors. The arm is normally activated by hand and it is usually provided with force return motors to transmit forces to the operator corresponding to interactions (real or simulated) between the slave arm and the environment, or dynamic forces originating within the arm, although these motors are not absolutely essential.

Although these arms are very convenient in that they make it possible to quickly and easily control a required state by the operator, some problems do arise. Complex control arms are based on the use of six degrees of freedom in the position and orientation in space of the manipulation device at the free end of the arm, or on most of these six degrees of freedom. The arm must be composed of a sufficiently large number of elements (called segments) to enable all these movements of the gripping device. But experience shows that singularities can occur, in other words positions of the manipulation device that are inaccessible or do not correspond to a determined position of the arm. The main reasons for these singularities are couplings between movements in the same direction at successive joints between segments, and more generally states in which there are too few or too many degrees of freedom of the arm that are free to occur.

Arm designers have successfully reduced the number of these singularities, but the arrangements that are most suitable in this respect are not always satisfactory since other requirements have to be respected, particularly the light weight of the arm, the small manipulation force and balancing of the arm in all positions without the arm collapsing or deforming in any other way as soon as it is released. It would be conceivable to oppose this type of deformation by allowing greater frictions at the joints of arm segments, but this would make the arm inconvenient to manipulate and is therefore unthinkable. Spring systems to individually balance the arm segments were also considered, according to the information in French patent 70 13606. This solution would be better, but cannot really be applied for complex arms since it is necessary not only to balance the weight of a segment, but also the bending moment of all other segments beyond it towards the free end of the arm, which is variable since this assembly can deform.

However, the invention provides a solution to these inadequacies in known arms. The main advantages of the invention are that the arm has a wide field of displacement without any singularity, and that its main elements remain in indifferent equilibrium.

In its most general form, the control arm comprising a train of segments finishing on a base and a wrist hinged to the train of segments at a hinge pin, is characterized in that the train of segments is made such that the angle between the hinge pin and a fixed plane is kept constant.

This arrangement makes it possible to create a well defined separation between translation control movements made by segments of the train and rotation control movements made by elements of the wrist on each side of the articulation connecting them, and facilitates balancing of the wrist and the rest of the arm by making the force applied by the wrist holder onto the train of segments constant. In particular, the train of segments can then be entirely balanced by spring devices without the need to use blocking or friction mechanisms at articulations that would make the manoeuvre difficult.

A feedback means suitable for keeping the angle between the wrist and a fixed plane constant includes a series of pulleys placed at successive hinge pivots of segments of the train, from the base as far as the wrist holder, and turning freely about the said pivots, except for the two end pulleys that are connected to the base and the wrist holder respectively, and belts tightened between the pulleys parallel to the segments and forming a chain.

A suitable wrist is composed of elements articulated to each other, and particularly with coincident axes of rotation, since it becomes easier to maintain its centre of gravity at a constant position.

More generally, it is advantageous if the train is composed of two segments connected together and to the base by pivots with a horizontal axis and if the base is connected to a fixed element by a pivot with a vertical axis; all arm translation movements are then authorized and static balancing of segments by springs becomes easy.

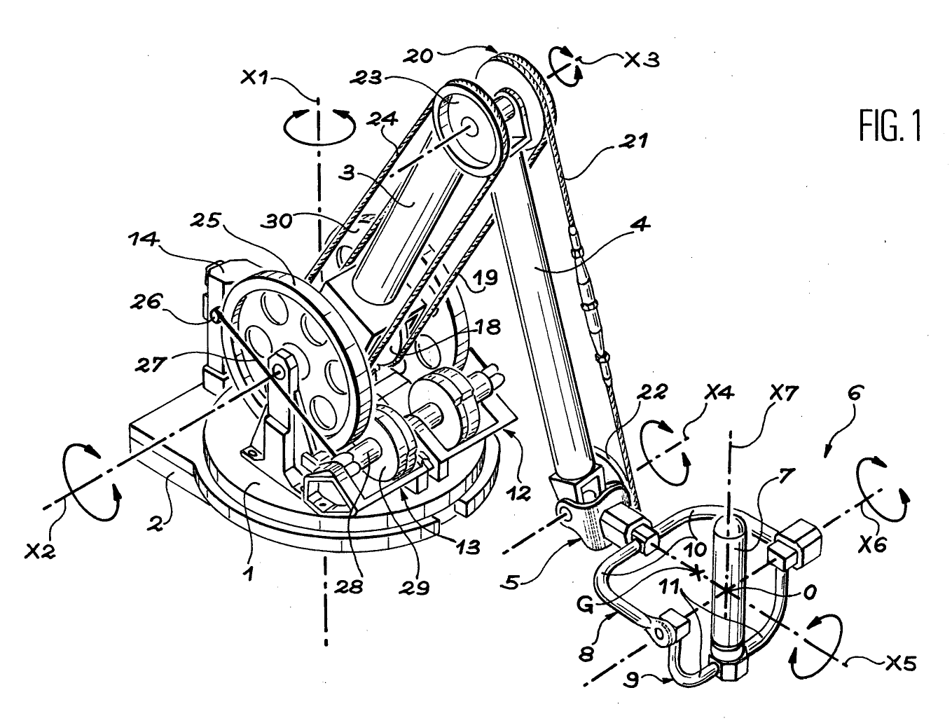

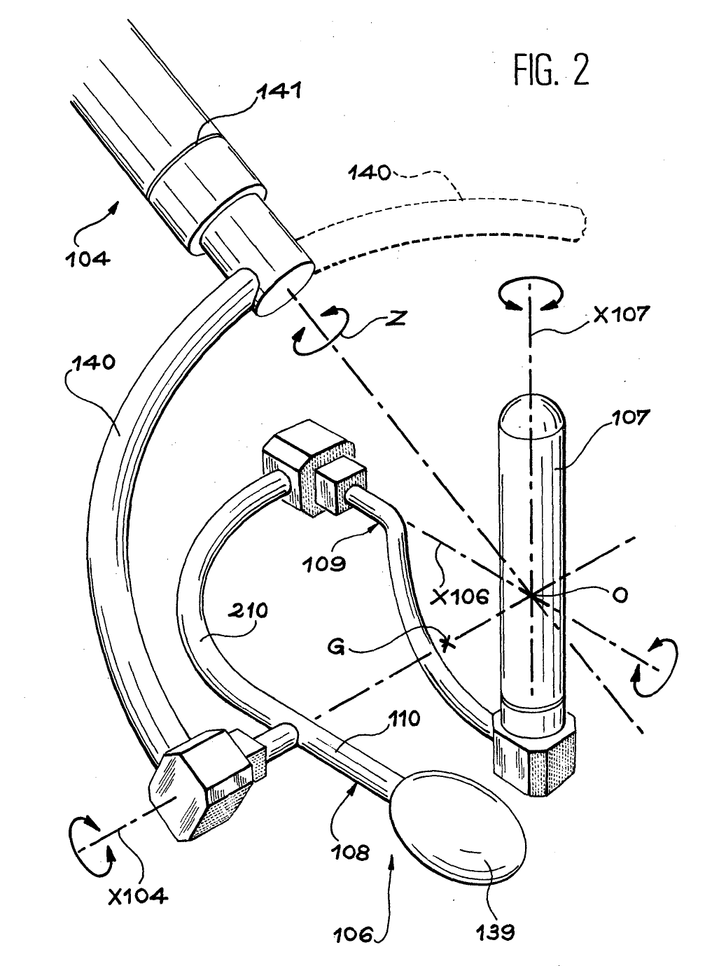

The invention will now be described by means of the figures, in which FIG. 1 represents a general view of the arm and FIG. 2 represents a variant of the end of the arm.

The arm is installed on a base 1 pivoting about a vertical axis X1 on a fixed support 2. A segment of the arm 3 rotates on the base 1 about a horizontal axis X2, the orientation of which depends on the rotations applied to the base 1. A forearm segment 4 is articulated to the arm segment 3 while being capable of rotating about an axis X3 (parallel to X2), by varying the angle between these segments. The other end of the segment of the forearm 4 finishes on the articulation of a wrist holder 5; the articulation axis X4 formed between them is parallel to the previous two axes. After the wrist holder 5, there are other elements of a wrist 6, namely a manipulation device composed in this case of a handle 7, and then two stirrups 8 and 9, the first of which is articulated through its centre to the wrist holder 5 about an axis X5, by the ends of its two branches 10 to the ends of the branches 11 of the other stirrup 9 by an axis X6; finally the stirrup 9 is articulated through its centre to the handle 7 through a final axis X7.

Therefore, this arm has seven apparent degrees of freedom at the X1 to X7 axes, and six real degrees of freedom excluding X4 as will be described later, and sensors such as angle encoders are placed at the real degrees of freedom X1, X2, X3, X5, X6 and X7 to measure the angles between the segments articulated at these joints, or the movements of these segments, to deduce controls to be imposed on another device according to a specific programming. Since this invention does not include anything about these sensors that is not already known, they will not be described any further.

The X5, X6, X7 axes are concurrent at a point O, and the stirrups 8 and 9 are approximately symmetric, such that the centre of gravity of the stirrup 8 lies on the X5 axis. Furthermore, the centre of gravity of the assembly composed of the other stirrup 9 and the handle 7 lies on the X7 axis, and possibly on the concurrent point O, and therefore also on the X5 axis.

Therefore, if the centre of gravity of the wrist 6 thus remains immobile at a point G on the X5 axis regardless of the movements applied to its elements about the X5, X6 and X7 axes, therefore it remains in an indifferent state of equilibrium. The wrist holder 5 is held at a constant elevation angle, in other words at a constant orientation from a horizontal plane, using a transmission described in more detail elsewhere. The result is that the bending moment exerted by the wrist 6 is resisted by this transmission and the arm segment 3 and the forearm segment 4 only need to resist the self-weight of the wrist 6, for all their positions and for all positions of wrist 6. It then becomes easy to balance the forearm segment 4 using a static balancing device 12 arranged on the base 1; another balancing device 13, also placed on base 1, is used to balance the arm segment 3.

Apart from this advantage, the wrist holder 5 held at a constant orientation from a fixed plane decouples degrees of freedom of the arm in translation accomplished by movements of the base 1 and segments 3 and 4, from degrees of freedom of the wrist 7 in orientation accomplished by movements of the wrist 6, which simplifies learning and control of the arm while contributing to eliminating kinetic singularities. It is clear that these singularities, which occur particularly when two segments have been made collinear, can only arise in this case when the arm is in its maximum extension and retraction states, when the angle between segments 3 and 4 becomes close to zero or 180°. Another aspect of this question applies to wrist 6; singularities occur if the handle 7 is facing the wrist holder 5, in other words if the X5 and X7 axes are coincident, or if it is collinear with segment 4; but these situations cannot easily occur if the wrist holder 5 is kept at a constant inclination and particularly close to the horizontal, since it would be necessary to completely invert the wrist 7 beyond a natural manoeuvring position for the operator.

The concept of the invention can be applied to different and possibly less complex arms; thus, five degrees of freedom of manoeuvre are frequently sufficient; in this case, for example, rotation of the handle 7 about the X7 axis can be blocked or made inactive, since this movement is the least convenient to accomplish.

Static balancing of the arm in the released state is completed by ordinary force feedback motors that stop rotations about the X1, X2 and X3 axes. A first motor (14) is fixed to the fixed support 2 and is connected to the base 1 through a belt tightened around the base, a gear or other means; two other motors, not shown in the figure, are installed on the base 1 and connected to the arm segment 3 by a pulley 30 and to the forearm segment 4 by a pulley 25, a belt 24 and a pulley 23 placed on the X3 axis. In this case also, all that are used are elements and processes known according to standard practice and therefore it is not worth describing them any further.

However, it is worthwhile completely describing the manner in which the elevation angle of the wrist holder 5 (from a horizontal plane) is maintained.

A reference pulley 18 is placed on the articulation axis X2 of the arm segment 3, but it is fixed on the base 1; a belt 19 is kept tensioned between it and a transmission pulley 20 placed on the articulation axis X3 of the arm segment 3 and the forearm segment 4 so as to turn freely; a second belt 21 is kept tensioned between another groove of the transmission pulley 20 and a support pulley 22 turning freely about the X4 axis but fixed to the wrist holder 5. The result of this construction is that the pulleys 20 and 22 do not rotate at all, any more than the wrist holder 5 since they are connected to the reference pulley 18 that is fixed, regardless of the movements of the arm segment 3 and the forearm segment 4.

Finally, the arm segment 3 and the forearm segment 4 are balanced at least partially by spring devices, possibly completed by force feedback motors. A peg 26 is placed at the periphery of a circular plate of the balancing pulley 25, and a cable 27 is attached to it; its opposite end is wound around a shaft 28 parallel to the X2 axis, which is retained in rotation by a spiral spring 29 attached between the shaft and the base 1. When the inclination of the forearm segment 4 is modified, the pulleys 23 and 25 rotate and the unwound length of the cable 27 is modified, which increases or reduces the force in the spiral spring 29 in proportion to the rotation of the shaft 28. The cable 27 then acts as a straight spring that will be tensioned between the peg 26 and the shaft 28, such that the information given in French patent 70 13606 mentioned above becomes applicable; if an appropriate choice is made for the constant of the spiral spring 29, the forearm segment 4 can be balanced regardless of its inclination; the position of the peg 26 is chosen such that the unwound length of the cable 27 is maximum when the forearm segment 4 applies the highest bending moment (when it is in the horizontal position).

The balancing device 12 of the arm segment 3 is similar and also comprises a spiral spring, a shaft, a cable, a peg and a pulley (marked reference 30 in the figure) rotating about the X2 axis, but the pulley is also fixed to the arm segment 3.

The combination of static balancing devices 12 and 13 reduces the weight of the arm by enabling the use of smaller force feedback motors to balance the arm about the X2 and X3 axes, which is exactly the position at which the forces to be balanced are greatest.

One particular form of a wrist 106 will now be described with reference to FIG. 2, at the end of an arm without a wrist holder, a first stirrup 108 being directly mounted in rotation about the transverse axis X104 at the end of the forearm segment 104, just like the X4 axis above. A second stirrup 109 is articulated to the first stirrup 108 about an axis X106, and a handle 107 pivots on the second stirrup 109 about an axis X107. The principle of the gyroscopic mounting at the three concurrent axes X104, X106 and X107, is maintained for convenience of manoeuvring the wrist and ease of balancing. In order to achieve this advantage, it is also useful if the concurrent point 0 of the three axes is aligned with the main portion of the forearm segment 104, which is the reason for placing the wrist 106 on a transferred end 140 of the segment 104. The centre of gravity G of the wrist 106 should be located on the axis X104 so it applies a constant force on the forearm segment 104, which can be achieved by putting a counterweight 139 on the first stirrup .108 at the end of a branch 110 opposite the branch 210 that supports the second stirrup 109 and the handle 107; advantageously, the common centre of gravity of these two elements may be placed on the axis X106 such that the stirrup 109 is also in indifferent equilibrium. In this second embodiment as well, the angle between the main axis X104 for articulation of the wrist 106 to the train of segments and a fixed plane (in this case horizontal plane) remains constant since the segments train cannot be rotated in torsion; in this case it is horizontal (like the X2 and X3 articulation axes of segments 3 and 4 to each other and to the base 1) and therefore it is difficult to align it with the X107 axis of the handle 107; this produces singularities; the situation is actually the same as in FIG. 1 with the X5 axis of the wrist holder 5.

It will be noted that the end of the arm is asymmetric and the wrist 106 only extends on one side of the handle 107, leaving the other side free for the operator's arm and hand. The arrangement shown is very good for manoeuvres with the right arm, but is not as good for manoeuvres with the left arm. Therefore it would be conceivable to use an inverter device for the wrist 106 such as turnbuckle 141 from which the transferred end 140 is suspended and which connects it to the rest of the forearm segment 104. The turnbuckle 141 is designed so that the transferred part 140 can be pivoted by a half turn about the axis of segment 104 as shown by arrow Z and placed in two opposite and symmetrical stop states; the other state is shown in dotted lines.

1. Control arm comprising a segments train (3, 4) finishing on a base (1), and a wrist (6, 106) articulated to the segments train at an articulation axis (X4, X104), characterized in that the segments train (3, 4) is made such that the angle between the articulation axis (X4, X104) and a fixed plane is held constant.

2. Control arm according to claim 1, characterized in that the plane is horizontal, the train is composed of segments (3, 4) connected to each other and to the base through pivots (X2, X3) with a horizontal axis and the base is connected to a fixed element (2) through a pivot (X1) with a vertical axis.

3. Control arm according to either of claims 1 or 2, characterized in that the wrist is articulated to the segments train by a wrist holder (5), and that a return means (18 to 22) keeps the angle between the wrist holder and a fixed plane constant.

4. Control arm according to any one of claims 1 to 3, characterized in that the return means comprises a sequence of pulleys (18, 20, 22) arranged at a sequence of articulation pivots (X2, X3, X4) of the segments (3, 4) of the train, from the base (1) as far as the wrist holder (5), the belts (18, 21) being tensioned between pairs of pulleys forming a chain parallel to the segments, the pulleys turning freely, except for two end pulleys that are fixed to the base (1) and the wrist holder (5) respectively.

5. Control arm according to claims 1 to 4, characterized in that at least some of the segments are balanced by spring devices (12, 13).

6. Control arm according to claim 1, characterized in that the segments (3, 4) of the train are connected to each other and the wrist by articulations of axes that are all parallel (X2, X3, X104).

7. Control arm according to any one of claims 1 to 6, characterized in that the wrist (6, 106) is composed of elements articulated to each other and balanced about the articulation axis (X5, X104).

8. Control arm according to any one of claims 1 to 6, characterized in that the wrist is composed of elements articulated about axes (X6, X7, X106, X107) that are concurrent at a concurrent point (O) in line with the articulation axis (X5, X104).

9. Control arm according to claim 8, characterized in that the concurrent point (O) is located in the middle of a wrist operating handle (7, 107).

10. Control arm according to claim 8 or 9, characterized in that the concurrent point (O) is aligned with a main portion of one of the segments (104), the said segment also comprising a laterally transferred portion (140) to which the wrist (106) is articulated.

11. Control arm according to claim 10, characterized in that the transferred portion (140) is mounted free to pivot between two opposite and symmetric positions on the main portion of the segment (104).
